(19) United States
(12) Patent Application Publication
(10) Pub. No.: US 2026/0020059 A1
(43) Pub. Date: Jan. 15, 2026

(54) MITIGATING CLOSE-IN-TIME COORDINATED-RESTRICTED TARGET WAKE TIMES FOR SERVICE PERIOD START TIMES IN WIFI COMMUNICATIONS

(71) Applicant: Cisco Technology, Inc., San Jose, CA (US)

(72) Inventors: Malcolm Muir Smith, Richardson, TX (US); Brian Donald Hart, Sunnyvale, CA (US); Binita Gupta, San Diego, CA (US)

(21) Appl. No.: 19/264,093

(22) Filed: Jul. 9, 2025

Related U.S. Application Data
(60) Provisional application No. 63/669,589, filed on Jul. 10, 2024.
(60) Provisional application No. 63/755,759, filed on Feb. 7, 2025.

(51) Int. Cl. H04W 74/0808

(52) U.S. Cl. CPC H04W 74/0808

(57) ABSTRACT

In one aspect, a method includes determining, at a first access point, that a transmit opportunity (TXOP) in a first Service Period (SP) of the first access point beginning at a first time extends beyond a Start Time Protection Rule (STPR) of a second access point at a second time, and overlaps with a second SP of the second access point that starts at the second time after the first time; continuing transmissions, by the first access point, in the TXOP of the first access point during the second SP; determining that the second access point has traffic to transmit; and granting, by the first access point, a portion of the TXOP of the first access point to the second access point.

### CROSS-REFERENCE TO RELATED APPLICATIONS

This application claims priority to and benefit of U.S. Provisional Application No. 63/669,589 filed on Jul. 10, 2024 and U.S. Provisional Application No. 63/755,759 filed on Feb. 7, 2025, the entire content of each of which is incorporated herein by reference.

### TECHNICAL FIELD

The present disclosure relates to wireless communication, and in particular to Transmission Opportunity (TXOP) sharing among neighboring access points to mitigate transmission degradations caused by near-in-time and/or overlapping Coordinated-Restricted Target Wake Times For Service Periods of such neighboring access points.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, where each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11bc) delivers speeds of up to 36 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a non-AP MLD with affiliated logical entities according to some aspects of the present disclosure.

FIG. 3 illustrates an example architecture 300 in which multi-AP coordination technologies may be practiced according to some aspect of the present disclosure.

FIG. 4 illustrates an example of close-in-time C-RTWT service periods of two APs, according to some aspects of the present disclosure.

FIG. 5 illustrates an example method for TXOP sharing between two or more access points according to some aspects of the present disclosure.

FIG. 6 illustrates an example process for determining that a nearby access point has traffic to send as part of example process of FIG. 5 according to some aspects of the present disclosure.

FIG. 7 shows an example of computing system according to some aspects of the present disclosure.

### DETAILED DESCRIPTION

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standard(s), the IEEE 802.15 standards, the Bluetooth® specifications as defined by the Bluetooth Special Interest Group (SIG), or the Long Term Evolution (LTE), 3G, 4G or 5G (New Radio (NR)) specifications promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

### Overview

Aspects of the present disclosure described below are directed to mechanisms for efficiently dealing with the case of close-in-time STPRs and avoid overlapping TXOPs. To do so, coordinating APs may agree to ignore peer APs' STPRs and perform a single longer TXOP that is shareable between the AP and its peer APs which are other nearby APs typically with periodic QoS traffic (according to buffered traffic, a priori known periodic traffic and priority), using Co-TDMA (and other coordination/sharing schemes).

In one aspect, a method includes determining, at a first access point, that a transmit opportunity (TXOP) in a first Service Period (SP) of the first access point beginning at a first time extends beyond a Start Time Protection Rule (STRP) of a second access point at a second time, and overlaps with a second SP of the second access point that starts at the second time after the first time; continuing transmissions, by the first access point, in the TXOP of the first access point during the second SP; determining that the second access point has traffic to transmit; and granting, by the first access point, a portion of the TXOP of the first access point to the second access point.

In another aspect, the method further includes negotiating with the second access point, extension of the TXOP beyond the second time.

In another aspect, determining that the second access point has traffic to transmit includes polling neighboring access points to determine, for each neighboring access point, transmission parameters including corresponding buffered traffic and associated transmission priority; and determining that the second access point has traffic to transmit based on the transmission parameters.

In another aspect, the first access point determines corresponding transmission parameters of at least two neighboring access points, and the method further includes granting the portion of the TXOP to one or more of the at least two neighboring access points based on one or more of a corresponding buffered traffic at each neighboring access point and corresponding transmission priority of buffered traffic at each neighboring access point.

In another aspect, determining that the second access point has traffic to transmit includes receiving, from the second access point, corresponding Periodic Traffic Scheduler Input (PTSI); and determining that the second access point has traffic to transmit based on the PTSI.

In another aspect, the PTSI is received from the second access point prior to the second time.

In another aspect, the PTSI indicates one or more of a start time, a period, and a burst duration of transmission need by the second access point upon arrival of traffic for transmission by the second access point at the second time.

In another aspect, the portion of the TXOP shared with the second access point is sharcable with at least a third access point by the second access point.

In another aspect, the method further includes polling, by the first access point, transmission parameters of neighboring access points, the transmission parameters including one or more of corresponding buffered traffic and associated priority, corresponding anticipated traffic, and associated transmission priority for each neighboring access point; and transmitting, by the first access point and to the second access point, the transmission parameters of the neighboring access points along with the portion of the TXOP.

In another aspect, the third access point uses the portion of the TXOP based on usage of the TXOP by the second access point and corresponding traffic priority associated with respective buffered traffic of the second access point and the third access point.

In one aspect, a first access point includes one or more memories having computer-readable instructions stored therein, and one or more processors. The one or more processors are configured to execute the computer-readable instructions to determine that a transmit opportunity (TXOP) in a first Service Period (SP) of the first access point beginning at a first time extends beyond a Start Time Protection Rule (STRP) of a second access point at a second time, and overlaps with a second SP of the second access point that starts at the second time after the first time; continue transmissions in the TXOP of the first access point during the second SP; determine that the second access point has traffic to transmit; and grant a portion of the TXOP of the first access point to the second access point.

In one aspect, one or more non-transitory computer-readable media include computer-readable instructions, which when executed by one or more processors of a first access point, cause the first access point to determine that a transmit opportunity (TXOP) in a first Service Period (SP) of the first access point beginning at a first time extends beyond a Start Time Protection Rule (STPR) of a access point at a second time, and overlaps with a second SP of the second access point that starts at the second time after the first time; continue transmissions, by the first access point, in the TXOP of the first access point during the second SP; determine that the second access point has traffic to transmit; and grant a portion of the TXOP of the first access point to the second access point.

### Example Embodiments

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11, via the 802.11bn amendment, is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination (MAPC) in Wi-Fi refers to a feature with multiple sub-features that enables multiple access points in one or more wireless networks to communicate with each other to negotiate and perform collaborative behaviors to avoid or minimize interference and ensure efficient and/or QoS-aware communication between the STA devices and the network(s). When multiple access points are deployed in a network—for instance in buildings and office complexes-they may operate on the same radio frequency, which can cause interference and degrade the network performance. To mitigate this issue, access points can be configured to coordinate their transmissions to minimize this interference and degradation. For instance, an AP aware of imminent (or imminently expiring) QoS traffic in a neighboring BSS might pause traffic in its own BSS in order to allow the neighboring traffic to go through with low delay and a reduced collision probability.

Wi-Fi 8 supports Multiple-Access Point (Multi-AP) coordination (MAPC) technologies such as Coordinated Time Division Multiple Access (Co-TDMA), coordinated Spatial Re-Use (Co-SR), and Coordinated-Restricted Target Wake Time (Co-RTWT), and Coordinated Beamforming (C-BF), to collaborate and coordinate resource allocation for optimized performance. Other techniques might build on these technologies such as such as Multi-AP-Coordination Service Periods (MAPC-SPs) that are an extension of Co-RTWT and Co-TDMA. Co-RTWT defines and makes use of the Start Time Protection Rule (STPR) that, after negotiation, is accepted by an adjacent Basic Service Set (BSS) such that at the start of each Co-RTWT Service Period (Co-RTWT-SP), one AP can transmit at a known time (i.e., with low latency) and with a low collision probability.

Once an AP becomes the TXOP holder (e.g., an AP that has gained access to the wireless medium for a specific duration), then the AP either performs access point to access point (AP2AP) polling to establish how much downlink and uplink (DL+UL) traffic is buffered at nearby cochannel APs and/or stations (STAs) in other BSSs and/or to determine priority and/or delay or expiry imminence for other APs or STAs and/or for the BSS of the AP. Alternatively, the AP uses prior information about periodic traffic in its own and other BSSs to select other APs and then performs Co-TDMA to grant time to the AP itself and to neighboring APs according to the amount, priority, and delay or expiry imminence of the buffered traffic. In some embodiments the AP2AP polling might provide minimal information and the TXOP holding AP must apply heuristics, perhaps informed by PTSIs, about the peer APs' likely traffic requirements.

However, the above approach, and especially reliance on the STPR of Co-RTWT agreements works well only if the APs can spread out their Co-RTWT allocations and make them non-overlapping. For example, each AP has a single RTWT flow leading to a Co-RTWT SP starting every 12 msec. Accordingly, when there are 6 overlapping APs, there is a STPR occurring every 2 milliseconds (ms). Additionally, if there is a clock offset between APs or other APs start their BSS or switch channels, or existing APs depart, then the gaps between STPR occurrences can grow very small (e.g., 0.5 or 0.1 msec). A very short gap leads to inefficiencies since the Physical layer Protocol Data Units (PPDUs) are very short and the Short Interframe Space (SIFS), preamble, and/or block acknowledgement (BA) overheads dominate. Meanwhile the two APs might be prepared to share their TXOP with each other (and other nearby needy APs) via Co-TDMA anyway. Therefore, artificially terminating the TXOP to conform to a neighboring AP's STPR “for fairness” or “because of the rules” is inefficient and rather pointless.

Aspects of the present disclosure described below are directed to mechanisms for efficiently dealing with the case of close-in-time STPRs and avoid overlapping TXOPs. To do so, coordinating APs may agree to ignore peer AP's STPRs and perform a single longer TXOP that is sharcable between the two APs with periodic QoS traffic (according to buffered traffic (e.g., buffered at the AP on the downlink and, for the uplink, known/expected to be buffered on the end device (non-AP MLD)), a priori known periodic traffic and priority), using Co-TDMA (and other coordination/sharing schemes). In another example, the longer TXOP may further be shared with other nearby APs (e.g., by the first AP and/or alternatively the second AP).

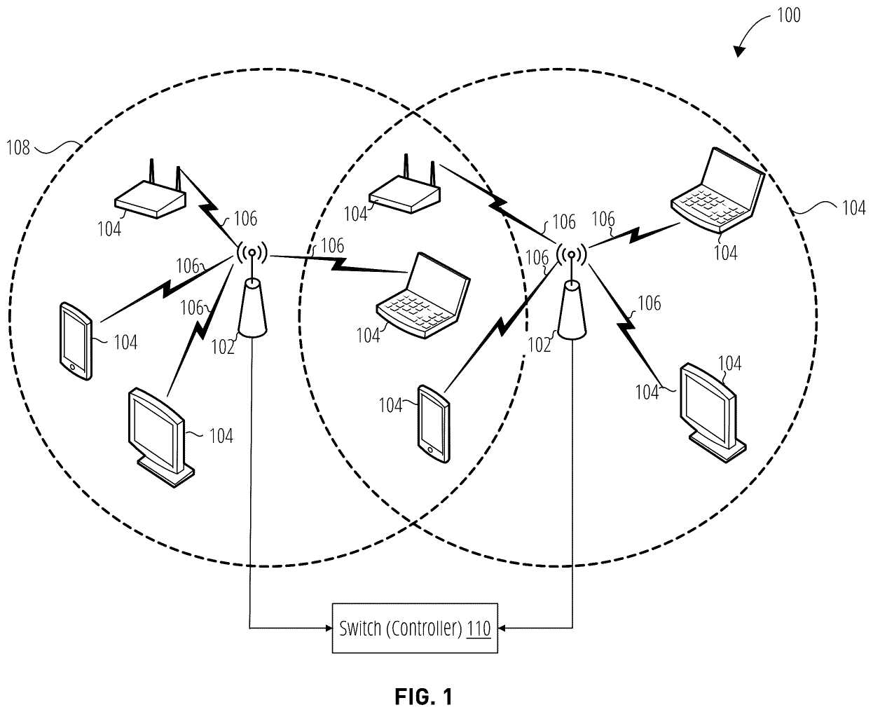

FIG. 1 illustrates a block diagram of an example wireless communication network according to some aspects of the present disclosure.

According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP, which can be one or more of a non-MLD AP, an AP affiliated with an AP MLD, and/or an AP MLD. In the examples presented herein, the AP can exclude an upper UMAC. Therefore, the AP can include the lower UMAC, LMAC, and/or PHY. Additionally, the WLAN can include one or more of STAs 104, which can be one or more of a non-MLD STA, a STA affiliated with a non-AP MLD, and/or a non-AP MLD. As illustrated, wireless communication network 100 also may include multiple APs such as APs 102 (may also be referred to as simply AP). APs 102 can be coupled to one another through a switch 110. While APs 102 are shown as being coupled to one another through switch 110, wireless communication network 100 can provide another device that allows the coupling of multiple APs. In another example, switch 110 can be a network controller configured to coordinate and manage operations of different APs such as APs 102.

Each of STAs 104 also may be referred to as a mobile station (MS), a mobile device, a mobile handset, a wireless handset, an access terminal (AT), a user equipment (UE), a subscriber station (SS), client, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STAs 104 can be referred to as clients and/or client devices.

Any one of APs 102 and an associated set of STAs (e.g., STAs 104) may be referred to as a basic service set (BSS), which is managed by a respective AP of APs 102. FIG. 1 additionally shows an example coverage area 108 of the each of APs 102, which may represent a basic service area (BSA) of wireless communication network 100. As illustrated, three of STAs 104 are within the BSA of each of APs 102. The BSS may be identified to users by a service set identifier (SSID), where the BSS might be one of many in the SSID. The BSS may be identified to other devices by a unique (or substantially unique) basic service set identifier (BSSID). One or more of APs 102 periodically broadcasts beacon frames (“beacons”) including the BSSID to enable STAs 104 that are within a wireless range of one or more of APs 102 to “associate” or re-associate with APs 102 to establish a respective communication link of communication links 106 (hereinafter also referred to as a “Wi-Fi link”), or to maintain communication links 106, with APs 102. For example, the beacons may include an identification of a primary channel used by respective AP of APs 102 as well as a timing synchronization function for establishing or maintaining timing synchronization with APs 102. APs 102 may provide communication links 106 to STAs 104 and therefore access to external networks. While the example has been described in regard to APs 102 and STAs 104, the present disclosure extends such that an AP may provide access to external networks to various STAs in a WLAN via communication links 106.

To establish communication links 106 with any one of APs 102, each of STAs 104 is configured to perform passive or active scanning operations (“scans”) on frequency channels in one or more frequency bands (for example, the 2.4 GHZ, 5 GHZ, 6 GHZ, or 60 GHz bands). To perform passive scanning, STAs 104 listen for beacons, which are transmitted by a respective AP of APs 102 at or near a periodic time referred to as the target beacon transmission time (TBTT) (measured in time units (TUs) where one TU may be equal to 1024 microseconds (μs)). To perform active scanning, STAs 104 generate and sequentially transmits probe requests on each channel to be scanned and listens for probe responses from APs 102. STAs 104 may be configured to identify or select an AP and thence a selected AP of APs 102 with which to associate based on the scanning information obtained through the passive or active scans, and to perform authentication and association operations to establish the communication links 106 with the selected AP of APs 102. The selected AP of APs 102 assigns an association identifier (AID) to STAs 104 at the culmination of the association operations, which selected AP of APs 102 uses to improve the efficiency of certain signaling to the STAs 104.

The present disclosure modified the WLAN radio and baseband protocols for the PHY and medium access controller (MAC) layers. APs 102 and STAs 104 transmit and receive wireless communications (hereinafter also referred to as “Wi-Fi communications”) to and from one another in the form of PHY protocol data units (PPDUs). APs 102 and STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

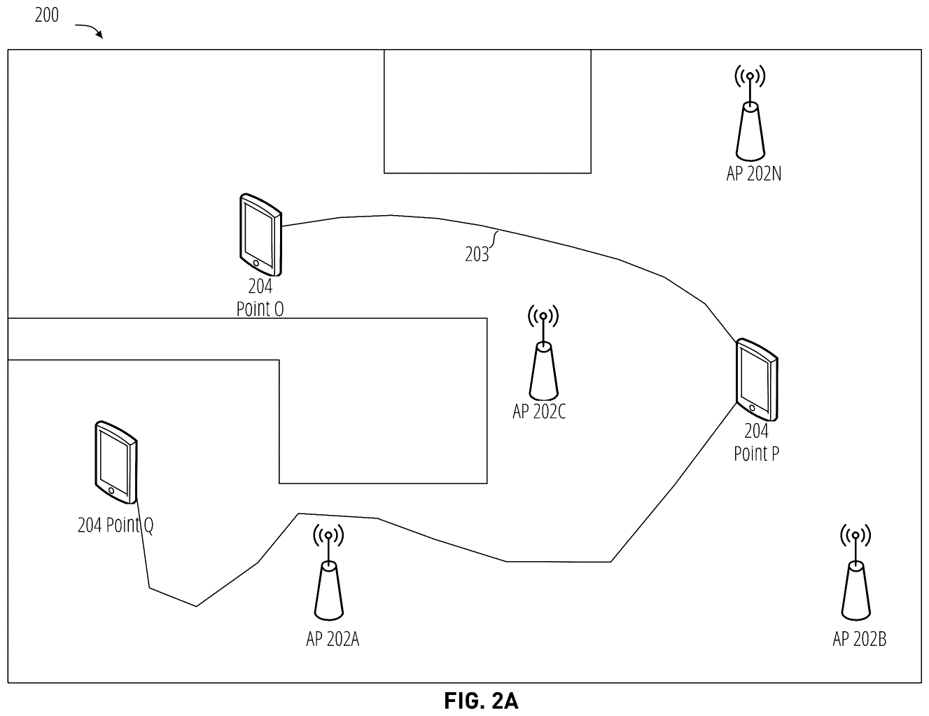

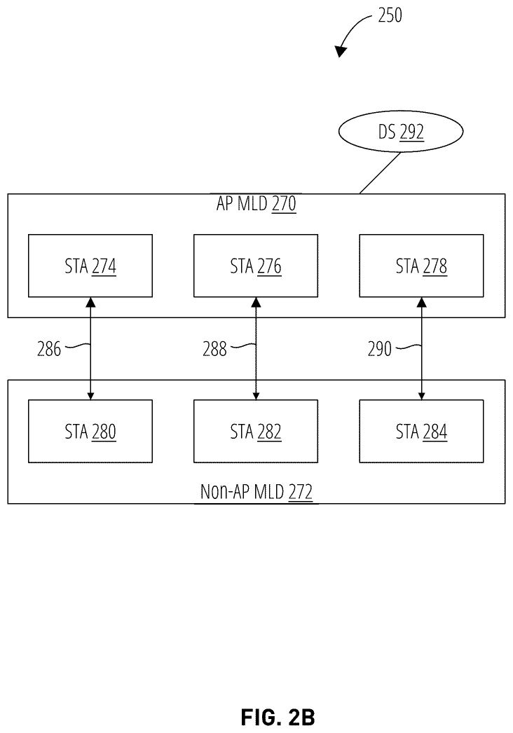

FIG. 2A illustrates an example of a single floor of building equipped with wireless communication according to some aspects of the present disclosure.

While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 200 includes AP 202A, AP 202B, AP 202C, and AP 202N. Each of the AP 202A, AP 202B, AP 202C, and/or AP 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP of AP 202A, AP 202B, AP 202C, and AP 202N may substantially overlap with the coverage of another AP of the AP 202A, AP 202B, AP 202C, and AP 202N.

As illustrated by line 203, STA 204 can move from point O to point P to point Q. When a STA 204 is moving around on a given floor, one or more of AP 202A, AP 202B, AP 202C, and AP 202N can be considered to be nearest to STA 204. Nearest as used in relation to AP 202A, AP 202B, AP 202C, AP 202N and STA 204 can include being physically nearest (for example, a Euclidean distance on the floor) and/or pathloss-nearest (for example, having the lowest wireless attenuation (pathloss) between a subset of APs, among all the APs, and the STA). Additionally, the pathloss-nearest approach can be used to reduce the likelihood of connection between an AP on a floor above or below STA 204. The location of the AP on the floor above or below might be closer in a Euclidean sense, but also not be a desirable AP for the connection of the device or station due to the floor location and/or possible signal interruption. The location of the AP on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs. The present disclosure provides for selecting the AP and/or providing a communication pathway from one or more STA through one or more APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logical affiliated AP such as AP 274, AP 276, and AP 278 operating in different channels and typically different frequency bands (e.g., 2.4 GHZ, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

It should be understood that although the example shows three logical entities within the AP MLD and the three logical entities within the non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure.

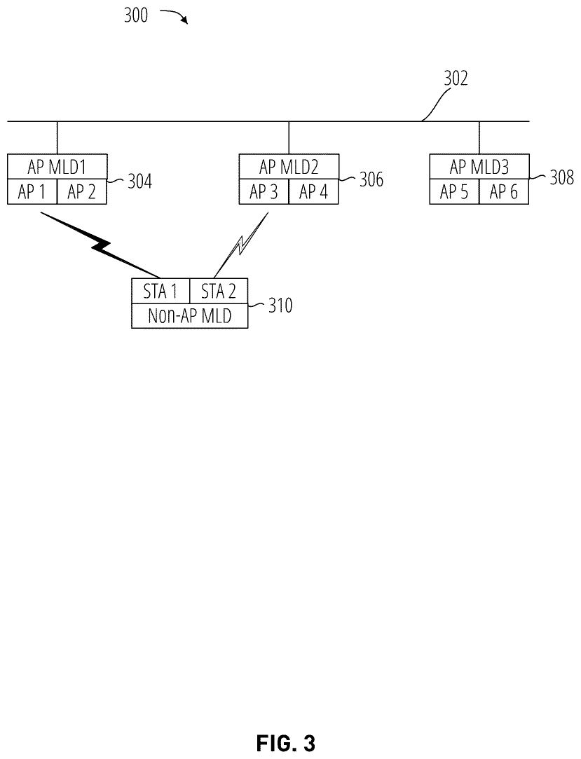

FIG. 3 illustrates an example architecture 300 in which multi-AP coordination technologies may be practiced according to some aspect of the present disclosure.

The architecture 300 includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). Architecture 300 also shows a non-AP MLD 310 that may be connected to AP MLD1 304.

In another example, AP MLD1 304, AP MLD2 306, and AP MLD3 308 may not belong to the same ESS and hence may not be logically connected via a DS. For example, AP MLD1 304 and AP MLD2 306 may belong to one administrative domain (e.g., a first organization occupying a 5^{th} floor of a building and having its own domain) while AP MLD3 308 belongs to another administrative domain (e.g., a second organization occupying a 6th floor of a building and having its own domain)

AP MLD1 304 may include one or more APs such as AP1 and AP2. AP1 and AP2 are typically implemented via different radios in the same housing but may be different physical APs (or AP interfaces) co-located in AP MLD1 304. Similarly, AP MLD2 306 may include one or more APs such as AP3 and AP4. AP3 and AP4 are typically implemented via different radios in the same housing but may be different physical APs (or AP interfaces) co-located in AP MLD2 306. Similarly, AP MLD3 308 may include one or more APs such as AP5 and AP6. AP5 and AP6 are typically implemented via different radios in the same housing but may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.). At least two APs in different AP MLDs, such as AP1, AP3 and AP5, operate on overlapped spectrum. The overlapped spectrum might be the same primary channel and bandwidth, same primary channel but different bandwidths, different primary channels and the same bandwidth, or different primary channels and bandwidths. The invention herein might be limited to a subset of these cases such as when the primary channel is shared.

The non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 3 and may be more or less.

As shown in FIG. 3, the non-AP MLD 310 is associated with the architecture 300 with multiple links setup with the AP MLD1 304 (for example, 2.4 GHz link with the AP1 for the STA 1 and 5 GHz link with the AP3 for the STA 2).

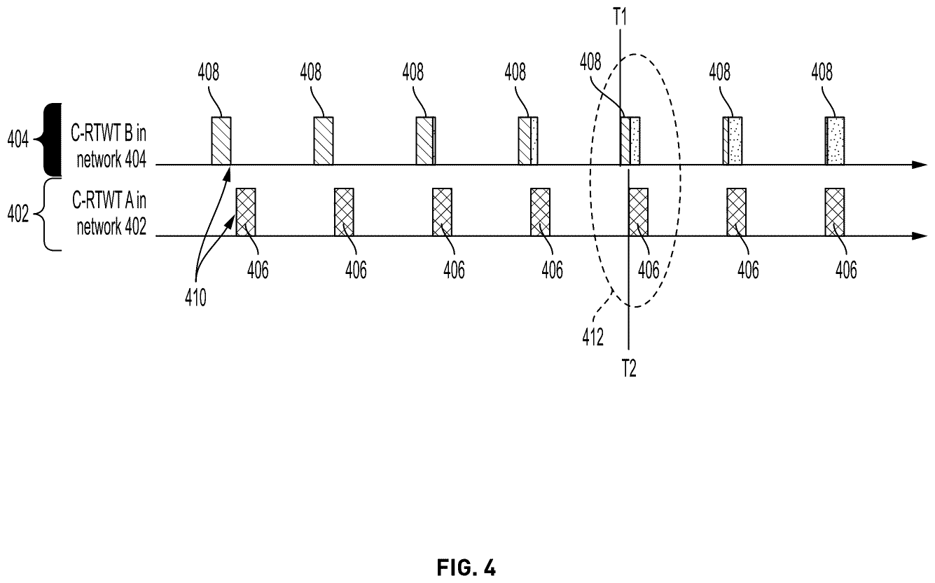

FIG. 4 illustrates an example of close-in-time Co-RTWT service periods of two APs, according to some aspects of the present disclosure. Techniques disclosed herein may be useful for APs in the same or different administrative domains to align their respective clocks and negotiate to avoid SP overlaps.

In example of FIG. 4, two adjacent networks (two different administrative domains) including network 402 and network 404 are shown. An AP in each of network 402 and 404 is shown having a respective RTWT agreement and has negotiated protection with the peer AP in order to “upgrade” the RTWT agreements to Co-RTWT agreements (e.g., Co-RTWT A in network 402 and Co-RTWT B in network 404). Furthermore, FIG. 4 shows a sequence of SPs 406 of network 402 and a sequence of SPs 408 of network 404. The sequence of SPs 406 and the sequence of SPs 408 may be periodic.

Initially, SPs of Co-RTWT A and Co-RTWT B may be non-overlapping with full SP duration available as, for example, shown at initial instance 410. However, due to a variety of reasons (e.g., due to unequalness in the spacings or periods of the two sequences (e.g., one periodic sequence is for a 50 Hz flow and one periodic sequence is for a 60 Hz flow), clock frequency drift (e.g., one periodic sequence is for a 59.999 Hz flow or that AP's clock is a few parts-per-million slower than nominal and the other is for a 60.001 Hz flow or that AP's clock is a few parts-per-million faster than nominal), etc.) in some instances of SP 406 may partially (or fully) overlap with SP 408 as, for example, shown in instance 412. Due to this overlap and the STPR, SP 406 may get minimal SP duration (i.e., truncated or runt). 412 shows an example of this. Each SP might comprise one or more TXOPs. One TXOP might span the boundary where the later-in-time SP begins (T2). In other words, TXOP of an AP in network 404 during SP 408 ends by time T2. This means that AP in network 402 has less time for relatively exclusive channel access and so might not be able to meet its underlying Quality of Service (QOS) goals, etc.

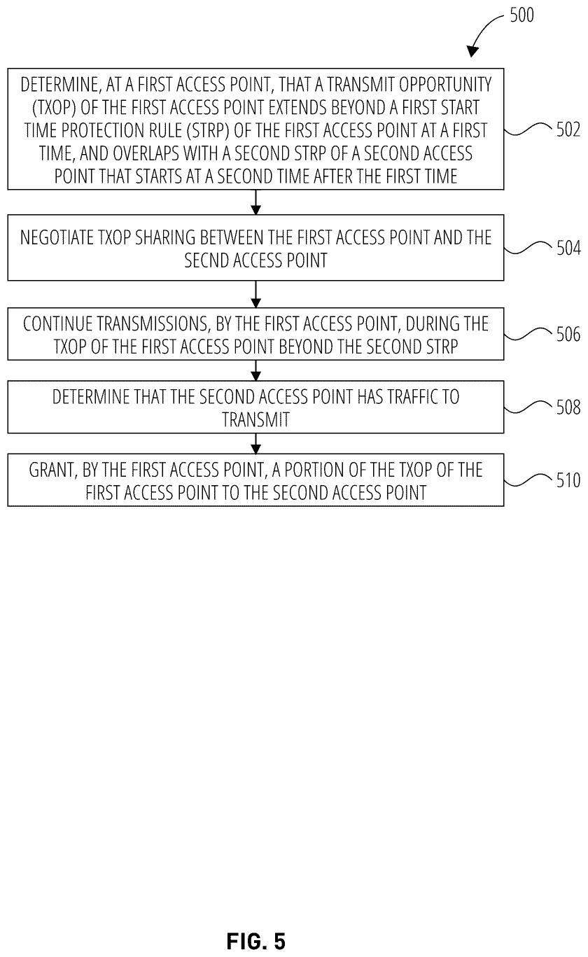

As noted above, in order to address overlapping and/or close-in-time Co-RTWT SPs, two APs (e.g., APs 102, two or more of AP MLD 304, AP MLD 306, and AP MLD 308) may agree to ignore the peer AP's STPRs and perform a single longer TXOP that is shareable between the two APs with periodic QoS traffic (according to buffered traffic, a priori known periodic traffic and priority), using Co-TDMA (and other coordination/sharing schemes). This will be further described below with reference to FIG. 5.

In another example, the longer TXOP may further be shared with other nearby APs (e.g., by the first AP and/or alternatively the second AP).

FIG. 5 illustrates an example method for TXOP sharing between two or more access points according to some aspects of the present disclosure.

Steps of FIG. 5 may be performed by any given access point (e.g., any one of APs 102, AP MLD 304, AP MLD 306, AP MLD 308, etc.) and/or alternatively by a centralized controller (e.g., switch 110 functioning as a network controller for managing operations of APs 102).

According to example process 500, at step 502, a first access point (e.g., one of APs 102, AP MLD 304, AP MLD 306, or AP MLD 308) and second access point (e.g., another one of APs 102, AP MLD 304, AP MLD 306, or AP MLD 308) may negotiate extending TXOP of first access point beyond STPR of second access point (TXOP sharing). For example, first access point can establish a TXOP that extends past the start time of second access point's SP if, in exchange, first access point determines the medium resources needed by second access point during Initial Control Frame (ICF)/Initial Control Response (ICR) exchange at the start of first access point's TXOP (or by some other means), and allocates commensurate medium resources to second access point during the TXOP.

In one example, this negotiation may occur with fairness guardrails. For example, negotiated extension of TXOP of the first access point may be such as that the total TXOP does not exceed a configurable TXOP limit. In some examples, if such limit would be violated, both first and second access points may downscale their allocations to avoid violating the limit, where the amount of downscaling might depend on the relative priority of the traffic, which AP is the TXOP holder and so forth.

At step 504, first access point may determine that a transmit opportunity (TXOP) within a SP of the access point that starts at a first time (e.g., T1 in FIG. 4) extends beyond a Start Time Protection Rule (STPR) of a second access point at a second time (e.g., T2 in FIG. 4), and so overlaps with a second SP of a second access point that starts at this second time after the first time. This determination may be performed according to any known or to be developed mechanism defined in the IEEE standards.

At step 506, the first access point continues transmissions in the TXOP of the first access point during the second SP of the second access point (beyond the STPR of the second access point).

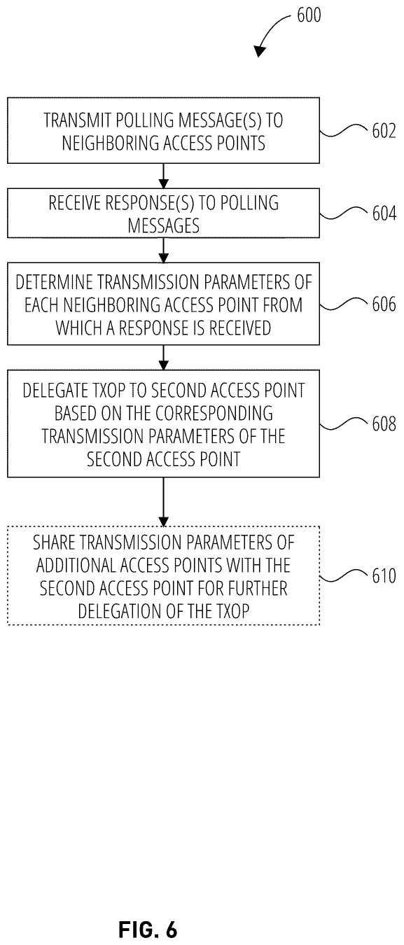

At step 508, which may occur before, after, or simultaneously with step 506, first access point determines that the second access point has traffic to transmit. First access point may determine transmission needs of second access point according to one or more of the following example processes. A first process may be via transmission and reception of polling messages, which will be described in more detail below with reference to FIG. 6 and/or via receiving Periodic Traffic Scheduler Input (PTSI) received from nearby access points, which will be described in more detail below.

In response to determining that the second access point has network traffic (traffic) to transmit and based on the mutually agreed upon TXOP sharing, at step 510, first access point, may grant (delegate) a portion of the TXOP of the first access point to the second access point in order for the second access point to transmit some or all of the buffered or anticipated traffic. This delegation process may be completed using any known or to be developed control frame according to the standards.

In one example, granting of the portion of the TXOP to the second access point may be performed via any one or more of Coordinated Time Division Multiple Access (Co-TDMA), Coded Orthogonal Frequency Division Multiple Access (Co-OFDMA), Coordinated Spatial Reuse (Co-SR), Coordinated Beamforming (Co-BF) and Coordinated Service Period (Co-SP). However, the present disclosure is not limited thereto.

FIG. 6 illustrates an example process for determining that a nearby access point has traffic to send as part of example process of FIG. 5 according to some aspects of the present disclsoure.

Steps of FIG. 6 may be performed by any given access point (e.g., any one of APs 102, AP MLD 304, AP MLD 306, AP MLD 308, etc.) and/or alternatively by a centralized controller (e.g., switch 110 functioning as a network controller for managing operations of APs 102).

In example process 600, at step 602, first access point may poll nearby (neighboring) access point(s) (transmit polling message(s)). This polling may be performed by first access point in order to determine current or very recent transmission needs of each of nearby access points with which first access point has an agreement to share TXOP. The polling may be performed periodically, at start of SP of first access point, prior to end of SP of first access point (e.g., end of T1), prior to start of SP of the second access point (e.g., T2), etc. Such polling may be performed via transmission of beacons, other management frames and/or control signaling mechanism defined in the standards.

At step 604 and in response to polling neighboring access point(s), first access point may receive a response from each polled access point including the second access point. The response message may be received via any known or to be developed management or control signaling mechanism defined in the standards.

At step 606, first access point may determine transmission parameters of each nearby access point from which a response is received. Transmission parameters can include, but are not limited to, buffered traffic at a corresponding nearby access point (in units of octets/frequency/spatial resources needed to deliver the buffered traffic, time needed to transfer the buffered data, or similar.), anticipated traffic burst at a corresponding nearby access point, associated transmission priority, etc. In another example, transmission parameters may be amount of buffered traffic at each priority, an indication of how time-urgent that traffic is (e.g., the time at which the head of line MSDU/MPDU of the buffer will expire).

In another example, in case of management frame signaling with Periodic Traffic Scheduler Inputs (PTSIs), parameters may also include periodicity and/or service interval (min and/or max), start time of the sequence, time when the sequence will expire (e.g., may be “indefinitely until told otherwise”), and instead of resources need for buffered traffic, it becomes resources needed for expected traffic.

At step 608, first access point may delegate a portion of TXOP (e.g., a remaining portion available beyond T2) to second access point based on transmission parameters of second access point. In one example, if second access point is the only access point with which first access point has TXOP sharing agreement, then access point may delegate all of available TXOP (e.g., beyond T2) to second access point or a portion thereof necessary for second access point to transmit buffered traffic at second access point. The first AP might resume transmission after it has granted a portion of the TXOP to the second AP and the second AP has completed its exchanges.

In one example, when using Co-OFDMA, Co-SR, Co-BF, first access point may delegate a portion of its frequency/spatial resources to second access point.

In some examples, first access point may have TXOP sharing agreement with more than just one neighboring access point (e.g., second and third access point). Each such access point may have corresponding buffered traffic and associated transmission priority. The amount of buffered traffic may be the same at each neighboring access point or may be different. Similarly, associated transmission priority of buffered traffic at each neighboring access point may be the same or different. In such scenarios, TXOP delegation by first access point may be performed in order to prioritize the most ‘needy’ one or more neighboring access points. Such prioritization may be based on transmission priority first followed by amount of buffered traffic or vice-versa.

For example, if both second and third access points have same amount of traffic buffered but with different transmission priorities, first access point may delegate available TXOP to one with higher transmission priority first.

In another example, if second access point has more buffered traffic than the third access point but transmission priority of the third access point is higher, first access point may still delegate available TXOP to third access point first. In another example, the access point with more buffered traffic may be prioritized over access point having buffered traffic with higher transmission priority.

In another example, if all access points have same amount of buffered traffic with same transmission priority, first access point may delegate the remaining TXOP equally among all such access points. In another example, the AP attempts to provide some resource allocation to each of them accounting for both priority and also some measure of time-since-last-had-service.

In optional step 610, first access point may send transmission parameters of additional neighboring access points to second access point along with available TXOP for further sequential TXOP delegation. A non-limiting example of such process may be as follows.

For example, at step 604 and 606, first access point may determine transmission needs of second, third, and fourth access points, each with corresponding buffered traffic and associated transmission priority. At step 608, first access point may delegate remaining portion of available TXOP to second access point and at the same time transmit to second access point transmission parameters of third and fourth access points. The transmission parameters of third and fourth access points may be sent to second access point in the same control frame via which the remaining TXOP is delegated to second access point.

Thereafter, second access point may use the delegated TXOP to complete its own transmission. Upon completing its own transmission, second access point may delegate any remaining portion of TXOP to third access point. Third access point may repeat a similar process as second access point to use TXOP and delegate any remaining portion to fourth access point and so on. In another example, the second access point may similarly delegate such remaining portion back to first access point.

In another example, at the time of polling at step 602 (e.g., at T1), second access point may not have any buffered traffic to transmit but may anticipate an incoming burst of network traffic at time T2. Therefore, a response to polling at T1 by second access point may result in first access point determining not to delegate available TXOP to second access point. Anticipation of incoming burst of network traffic at T2 may be via Stream Classification Service with Quality of Service Characteristics SCS (QC), Deep Packet Inspection (DPI), traffic pattern classification (e.g., Network-Based Application Recognition (NBAR), etc.

This issue may be addressed via sharing of Periodic Traffic Scheduler Inputs (PTSIs) between first access and neighboring access point(s) such as second access point, beforehand (e.g., via an AP2AP secure tunnel via the wireless link or out of band (e.g., via Ethernet broadcasts or via a controller). This sharing may be performed prior to or near the start the underlying flow and thus prior to (or at least near the start of) of all the SPs to assist that flow. Sharing of PTSIs enable first access point to be aware a priori of the second access point's upcoming need for medium time at T2 through PTSI information such a start time, a period, a burst duration, a priority, an expiry time, etc. for anticipated/upcoming traffic transmission. First access point may then delegate available TXOP to nearby access points to allow for second access point to be granted medium time shortly after T2.

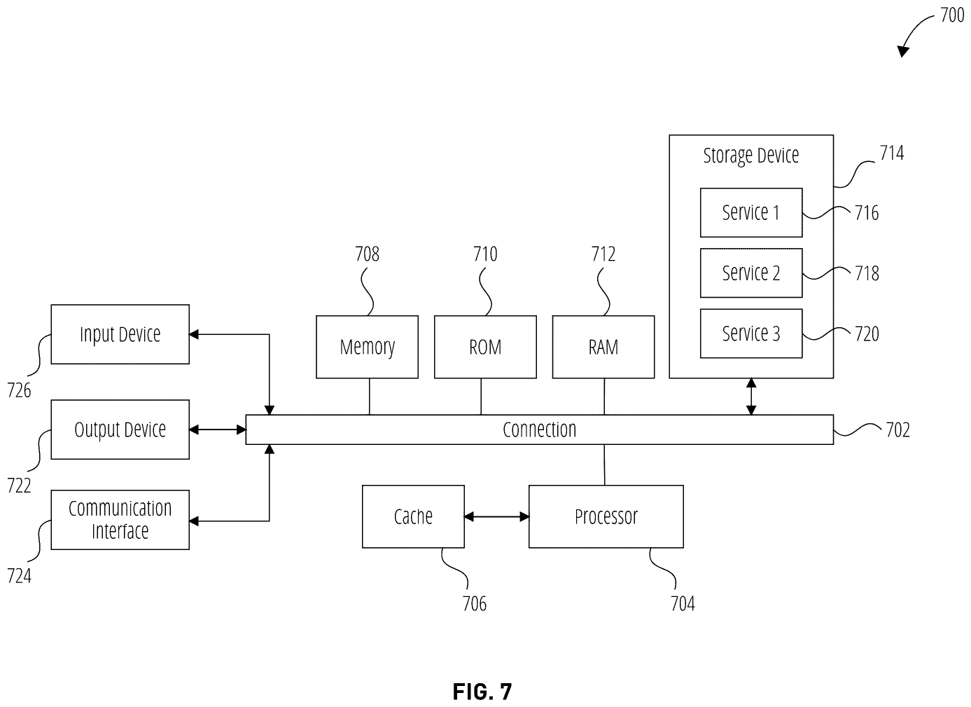

FIG. 7 shows an example of computing system according to some aspects of the present disclosure.

For example, computing system 700 may be any component of wireless communication network 100 and settings shown in FIGS. 1-3 such as APs 102, switch 110 (controller), STAs 104, APs and devices shown in FIGS. 2A and 2B, AP MLD 1 304, AP MLD 2 306, AP MLD 3 308, non-AP MLD 310, and/or any component of thereof. Various components of computing system 700 may be in communication with each other using connection 702. Connection 702 can be a physical connection via a bus, or a direct connection into processor 704, such as in a chipset architecture. Connection 702 can also be a virtual connection, networked connection, or logical connection.

In some examples, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) such as processor 704 and connection 702 that couples various system components including system memory 708, such as read-only memory (ROM) such as ROM 710 and random access memory (RAM) such as RAM 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method comprising:
determining, at a first access point, that a transmit opportunity (TXOP) in a first Service Period (SP) of the first access point beginning at a first time extends beyond a Start Time Protection Rule (STPR) of a second access point at a second time, and overlaps with a second SP of the second access point that starts at the second time after the first time;
continuing transmissions, by the first access point, in the TXOP of the first access point during the second SP;
determining that the second access point has traffic to transmit; and
granting, by the first access point, a portion of the TXOP of the first access point to the second access point.

2. The method of claim 1, further comprising:
negotiating with the second access point, extension of the TXOP beyond the second time.

3. The method of claim 1, wherein determining that the second access point has traffic to transmit, comprises:
polling neighboring access points to determine, for each neighboring access point, transmission parameters including corresponding buffered traffic and associated transmission priority; and
determining that the second access point has traffic to transmit based on the transmission parameters.

4. The method of claim 3, wherein,
the first access point determines corresponding transmission parameters of at least two neighboring access points, and
the method further comprises granting the portion of the TXOP to one or more of the at least two neighboring access points based on one or more of a corresponding buffered traffic at each neighboring access point and corresponding transmission priority of buffered traffic at each neighboring access point.

5. The method of claim 1, wherein determining that the second access point has traffic to transmit, comprises:
receiving, from the second access point, corresponding Periodic Traffic Scheduler Input (PTSI); and
determining that the second access point has traffic to transmit based on the PTSI.

6. The method of claim 5, wherein the PTSI is received from the second access point prior to the second time.

7. The method of claim 6, wherein the PTSI indicates one or more of a start time, a period, and a burst duration of transmission need by the second access point upon arrival of traffic for transmission by the second access point at the second time.

8. The method of claim 1, wherein the portion of the TXOP shared with the second access point is shareable with at least a third access point by the second access point.

9. The method of claim 8, further comprising:
polling, by the first access point, transmission parameters of neighboring access points, the transmission parameters including one or more of corresponding buffered traffic and associated priority, corresponding anticipated traffic, and associated transmission priority for each neighboring access point; and
transmitting, by the first access point and to the second access point, the transmission parameters of the neighboring access points along with the portion of the TXOP.

10. The method of claim 9, wherein the third access point uses the portion of the TXOP based on usage of the TXOP by the second access point and corresponding traffic priority associated with respective buffered traffic of the second access point and the third access point.

11. A first access point comprising:
one or more memories having computer-readable instructions stored therein; and
one or more processors configured to execute the computer-readable instructions to:
determine that a transmit opportunity (TXOP) in a first Service Period (SP) of the first access point beginning at a first time extends beyond a Start Time Protection Rule (STPR) of a second access point at a second time, and overlaps with a second SP of the second access point that starts at the second time after the first time;
continue transmissions in the TXOP of the first access point during the second SP;
determine that the second access point has traffic to transmit; and
grant a portion of the TXOP of the first access point to the second access point.

12. The first access point of claim 11, wherein the one or more processors are configured to execution the computer-readable instructions to:
negotiate with the second access point, extension of the TXOP beyond the second time.

13. The first access point of claim 11, wherein the one or more processors are configured to execution the computer-readable instructions to determine that the second access point has traffic to transmit by:
polling neighboring access points to determine, for each neighboring access point, transmission parameters including corresponding buffered traffic and associated transmission priority; and
determining that the second access point has traffic to transmit based on the transmission parameters.

14. The first access point of claim 13, wherein,
the first access point determines corresponding transmission parameters of at least two neighboring access points, and
the one or more processors are configured to execute the computer-readable instructions to grant the portion of the TXOP to one or more of the at least two neighboring access points based on one or more of a corresponding buffered traffic at each neighboring access point and corresponding transmission priority of buffered traffic at each neighboring access point.

15. The first access point of claim 11, wherein the one or more processors are configured to execute the computer-readable instructions to determine that the second access point has traffic to transmit by:
receiving, from the second access point, corresponding Periodic Traffic Scheduler Input (PTSI); and
determining that the second access point has traffic to transmit based on the PTSI.

16. The first access point of claim 15, wherein the PTSI is received from the second access point prior to the second time.

17. The first access point of claim 16, wherein the PTSI indicates one or more of a start time, a period, and a burst duration of transmission need by the second access point upon arrival of traffic for transmission by the second access point at the second time.

18. The first access point of claim 11, wherein the portion of the TXOP shared with the second access point is shareable with at least a third access point by the second access point.

19. The first access point of claim 18, wherein the one or more processors are configured to execute the computer-readable instructions to:
poll transmission parameters of neighboring access points, the transmission parameters including one or more of corresponding buffered traffic and associated priority, corresponding anticipated traffic, and associated transmission priority for each neighboring access point; and
transmit, by the first access point and to the second access point, the transmission parameters of the neighboring access points along with the portion of the TXOP.

20. The first access point of claim 19, wherein the third access point uses the portion of the TXOP based on usage of the TXOP by the second access point and corresponding traffic priority associated with respective buffered traffic of the second access point and the third access point.
